(19) United States
(12) Patent Application Publication
(10) Pub. No.: US 2007/0019439 A1
(43) Pub. Date: Jan. 25, 2007

(54) BACK LIGHT UNIT AND METHOD OF ADJUSTING SPECTRAL DISTRIBUTION THEREOF

(76) Inventors: Chuan-Pei Yu, I-Lan Hsien (TW); Mao-Jung Wang, Chi-Lung City (TW)

Correspondence Address: NORTH AMERICA INTELLECTUAL PROPERTY CORPORATION, P.O. BOX 506, MERRIFIELD, VA, 22116, US

(21) Appl. No.: 11/307,494

(22) Filed: Feb. 9, 2006

(30) Foreign Application Priority Data
Jul. 21, 2005 (TW) 094124685

(51) Int. Cl. F21V 7/04

(52) U.S. Cl. 362/621; 362/608; 362/612

(57) ABSTRACT

A back light unit having a light guide plate, a light guide bar connecting to the light guide plate, at least a white LED light source, and at least a color LED light source. Each of the LED light sources is positioned at a side of the light guide bar. The color LED light source compensates white light from the white LED light source that cannot produce preferable white light. Accordingly, the back light unit can produce white light that provides preferable color saturation to a display in cooperation of the white LED light source and the color LED light source.

### BACKGROUND OF THE INVENTION

1. Field of the Invention

The invention relates to a back light unit, and more particularly, to a back light unit using light emitting diodes (LEDs) as its back light source.

2. Description of the Prior Art

A light emitting diode (LED) is a new type of small light sources. It has advantages of long life, small size, high shock resistance, and low power consumption. As a result, LEDs have been widely used as the indicator lights or light sources of electronic appliances and machines. Recently, due to the development of the colorfulness and brightness of LEDs, they had been applied to mobile electronics as the back light sources of the mid- or small-size displays, especially for the small color liquid crystal displays (LCD).

Because white lights are used as the major back light source for the LCD displays of most information electronic products, the LEDs used in the back light units must be able to produce white lights. However, comparing to the lighting equipments which are currently popular, such as incandescent tungsten lamps and fluorescent lamps, the technology of white LED is not mature yet for that the white LED light is more costly and less efficient. Furthermore, it also has the disadvantage of smaller spectral distribution. Currently two methods are used in the industry to produce white LED lights. The first method is to use a blue LED chip with yellow-green phosphor to produce white light. This method has low cost and low efficiency wherein it is widely used by the industry. However, the problem is that the white light produced with this method may have insufficient intensities of the red light between 600 to 700 nanometers (nm) and of the green light between 480 to 580 nm. The insufficiency of the red light is enormous. This problem affects the color saturation of LCD displays. The manufacturers now use color filters to increase the color saturation, which raises the cost dramatically due to the difficulties in processing and uncontrollable yield rates.

Another method is to package a red, a blue and a green LED chips as a single package, and adjust the electric currents among the LED chips to produce white light. This method provides the light sources with the wavelengths of red, blue, and green lights. Nevertheless, it has difficulties in controlling the brightness of each individual LED chips and in adjusting the uneven mixture of colors. And the efficiency of emitting light is still low. In addition, since all three LED chips are lightened simultaneously, more voltages are required in this kind of back light units than those with a single LED chip; the power consumption of the displays is increased.

As a result, it is still a topic which must be researched in the industry to improve the white light emitted by LED light source with low cost.

### SUMMARY OF THE INVENTION

It is therefore a primary objective of the claimed invention to provide a back light unit producing white light with preferable color saturation and a method of adjusting spectral distribution of a back light unit to solve the problems of displays which can not produce preferable colors due to the limited technology of white LED light sources.

According to the claimed invention, the back light unit comprises a light guide plate, a light guide bar connecting to the light guide plate, at least a white LED light source, and at least a color LED light source. Each of the LED light sources is positioned on a side of the light guide bar.

According to the claimed invention, a method of adjusting spectral distribution of a back light unit is further provided. The back light unit comprises a light guide plate and a white LED light source. First the spectrum diagram of the white light emitted by the white LED light source is compared with that of the natural light. A kind of light with a specific range of wavelength which the white light emitted by the white LED package lacks is determined. Then a color LED light source for the light with the specific wavelength is provided so that the lights from the white LED light source and from the color LED light source can be mixed in the light guide plate to produce white light with preferable color saturation.

It is an advantage of the technology of color LED light sources with single LED chip is fully developed so that it may be used to effectively adjust the white light having small spectral distribution that is produced by the white LED light source with immature technology. Accordingly, the back light unit may provide a white light source close to the natural light to the display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a back light unit according to a first embodiment of this invention.

FIG. 2 is a schematic diagram of a back light unit according to a second embodiment of this invention.

FIG. 3 is a schematic diagram of a back light unit according to a third embodiment of this invention.

FIG. 4 is a schematic diagram of a back light unit according to a forth embodiment of this invention.

FIG. 5 is a schematic diagram of a back light unit according to a fifth embodiment of this invention.

### DETAILED DESCRIPTION

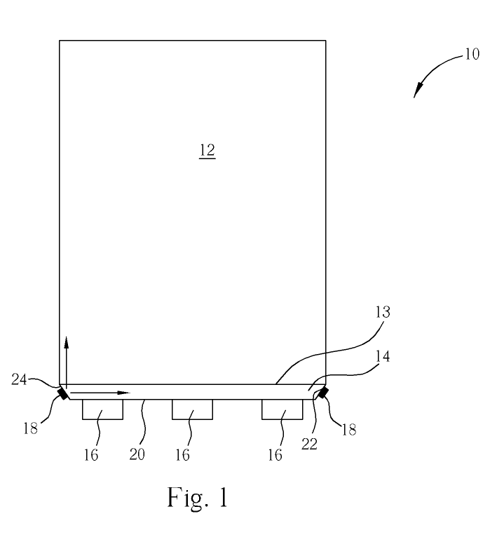

Please refer to FIG. 1. FIG. 1 is a schematic diagram of a back light unit 10 according to a first embodiment of the in this invention. The back light unit 10 comprises a light guide plate 12, a light guide bar 14 on one side of the light guide plate, three white LED light sources 16 on the side of the light guide bar 14 opposite to the side connecting to the light guide plate 12, and two color LED light sources 18. As shown in FIG. 1, the light guide plate 12 is a flat or wedge-shaped plate. One side of the light guide plate 12 is an incidence face 13 of the light guide plate 12. A light guide bar 14 is set on this incidence face 13 and connects to the light guide plate 12. The light guide bar 14 and the light guide plate 12 may be a monolithic structure or be made of same materials. The first light-incidence face 20 of the light guide bar 14 is positioned at the surface opposite to the incidence face 13 of the light guide plate 12. Two sides of the light guide bar 14 are two nicks, and the second light-incidence face 22 and the third light-incidence face 24 of the light guide bar 14 are on the two nicks. Three white LED light sources 16 are set in a row on the surface of the first light-incidence face 20. Two color LED light sources 18 are individually set on the edge of two sides of the light guide bar 14, the second and the third light-incidence faces 22, 24.

In this embodiment, each of the package of the white LED light sources 16 is composed by a blue LED chip with yttrium aluminum garnet (YAG) or other similar yellow-green phosphor. The white light produced by this package has small spectral distribution and lacks the color of red light. Therefore, to compensate the shortage of red light in the white light produced by the white LED light sources 16, a red light LED package with a single red LED chip is used as the color LED light source 18 on each side of the light guide bar 14. Via the light guide bar 14, the red light is transmitted from the color LED light sources to the light guide plate 12. The light from the color LED light sources 18 then may be fully mixed with the white light from the white LED light sources 16 to provide a complete white light source with wavelengths of red, blue, and green lights. In addition, while the color LED light sources 18 are being positioned, the included angles of the nicks between the first and the second light-incidence faces 20,22 and between the first and the third light-incidence faces 20, 24 of the light guide bar 14 may be modified based on the propagating angles of the light from the package of the color LED light sources 18 (about 110 degrees) to adjust the incidence angle of the color light on the light guide plate 12, as the arrows shown in FIG. 1. A distinguish feature of this embodiment is to set up the color LED light sources 18 on two sides of the plurality of the white LED light sources 16 which have insufficient spectral distribution or on two sides of the light guide plate 12 and the light guide bar 14. By adjusting or special designs of the face of the nicks between the first light-incidence face 20 and the second or third light-incidence faces 22, 24 of the light guide bar 14, the light of the color LED light sources 18 is uniformly transmitted to the light guide plate 12 to compensate the shortage of the white light produced by the white LED light sources 16.

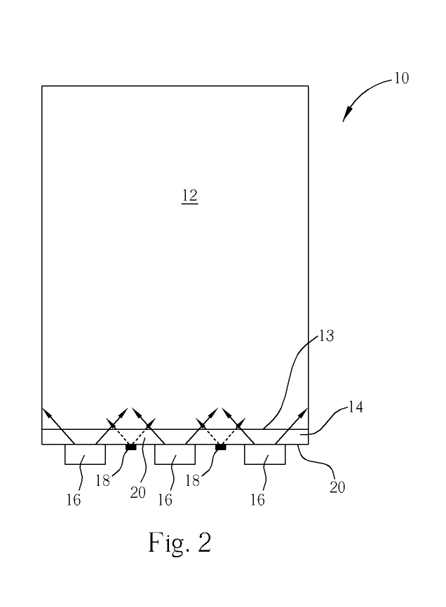

Please refer to FIG. 2. FIG. 2 shows the second embodiment of the back light unit according to the present invention. The symbols of each part here are the same as in the previous embodiment. In this embodiment, the color LED light sources 18 are set between each two nearby white LED light sources 16 and on the surface of the first light-incidence face 20. Therefore, the light produced by the white LED light sources 16 and the color LED light sources 18 will be mixed completely in the light guide bar 14, and provide white light with preferable color saturation to the light guide plate 12. The arrows with solid lines in FIG. 2 indicate the light produced by the white LED light sources 16, and the arrows with dashed lines indicate the light produced by the color LED light sources 18.

In the above-mentioned first and second embodiments, a white LED light source 16 comprises a single blue chip with phosphor. The light produced by these light sources lacks the light with red wavelength. Therefore, the single-chip red LED light packages are used as the color LED light sources 18 to compensate the insufficiency in colors. Because the brightness or intensity of red LED chips is weaker than the white LED light sources 16, multiple red LED light sources 18 added onto the back light unit 10 may effectively compensate the lack of the white light from the white LED light sources 16 and improve the color performance of the back light unit 10.

Similarly, when the white LED light source 16 is composed of color LED chip other than blue LED chips, different color LED light sources, usually single-chip packages, may be used to compensate the specific range of wavelength which is missing in the white light produced by the white LED light sources and is identified by the comparison of the spectrum diagrams of the white light and the natural light. The position and design of the light guide plate 12 and the light guide bar 14 may be used to adjust and mix the light from the white LED light sources and the color LED light sources to provide preferable light sources to the back light unit. Therefore, other than the single-chip packages with red LED chips, the single-chip packages with green chips or chips in different colors may be used as the color LED light sources to compensate the weak colors in the white light. The single-chip LED packages with well-developed technology hereby may be used to easily adjust the colors of the back light unit to provide the preferable back light source to the market.

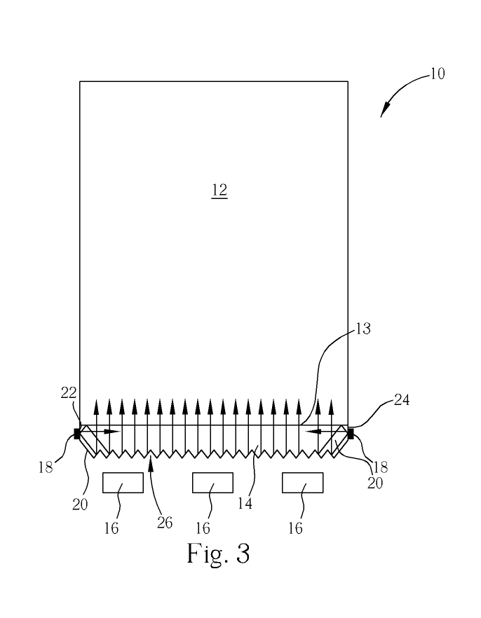

Please refer to FIG. 3. FIG. 3 shows the third embodiment of the back light unit of the present invention. All symbols used for parts here are the same as in previous embodiments. In this embodiment, the first light-incidence face 20 of the light guide bar 14 further comprises a plurality of V-cuts 26 or has been roughened. As a result, the light from the color LED light sources 18 on the second and third light-incidence faces 22, 24 may be transmitted to the center of the light guide bar 14. Also, due to the differences between the refraction in the air and the refraction in the light guide bar 14, the V-cuts 26 or rough edges of the light guide bar 14 may serve as a prism structure that creates a prism effects and reflect the light to the light guide plate 12 through its incidence face 13 (the light-exit face of the light guide bar 14), as the arrows show in FIG. 3.

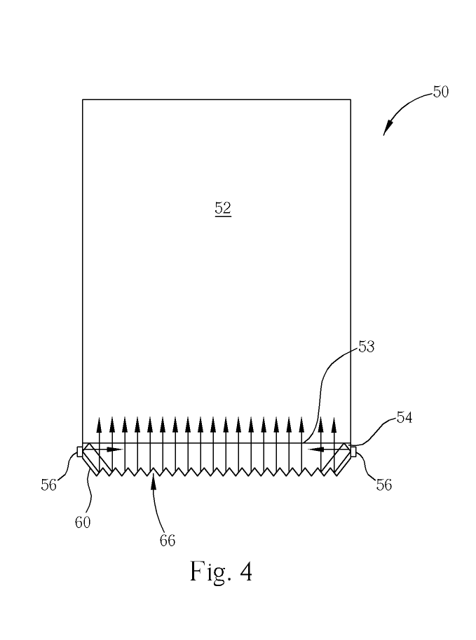

Please refer to FIG. 4. FIG. 4 is a schematic diagram of the forth embodiment of the present invention. The back light unit 50 comprises a light guide plate 52, a light guide bar 54, and at least a white LED light source 56. FIG. 4 shows two white LED light sources 56. Each of the white LED light source 56 is a double-chip LED package comprising a red LED chip, a blue LED chip, and florescent powders. It produces white light comprising the wavelengths of red, blue, and green lights, while it usually has a problem of uneven color mixing. To solve the problem, two double-chip white LED light sources 56 are separately set up on two sides of the light guide bar 54, and the surface 60 of the light guide bar 54 has been specially processed.

The surface 60 of the light guide bar 54 may contain V-cuts 66 or may be roughened to create the prism effects. Due to the differences between the refractions in the air and in the light guide bar 54, the light from the white LED light sources 56 may be transmitted to the center of the light guide bar 54, and reflected into the light guide bar 54, completely mixed, and then transmitted into the light guide plate 52, as the arrows shown in FIG. 4. This design effectively solves the problems of color underperformance of displays due to the uneven color mixtures and uneven brightness created by the direct light incident on the light guide plate 52 from the double-chip white LED light sources 56. It should be noted that adjusting the angles and pitches of V-cuts 66 may create better reflection angles of the light and mixture in both this embodiment and the third embodiment.

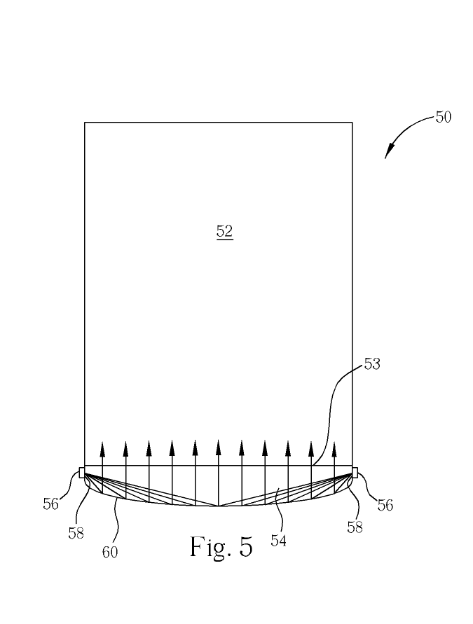

Please refer to FIG. 5. FIG. 5 is a schematic diagram of the fifth embodiment of the present invention. The symbols for parts here are the same as in the forth embodiment. In this embodiment, the surface of the side 60 of the light guide bar 54 opposite to the incidence face 53 of the light guide plate is convex. The double-chip white LED light sources 56 are still set on the two light-incidence faces 58 of the light guide bar 54. While the light from the white LED light sources 56 is transmitted in the light guide bar 54, partial light incident to the convex side 60 will be reflected to the light guide bar 54, and then be uniformly transmitted to the light guide plate 52. Accordingly, the side 60 serves as a reflection face of the light guide bar 54 for reflecting light passing into the light guide bar 54 through the light-incidence face 58 back to the light guide bar 54. Therefore, with the special design on the surface of the side 60 of the light guide bar 54, the light from the white LED light sources 56 in this embodiment is uniformly reflected and fully mixed to create a preferable white light in the light guide plate 52.

In the forth and fifth embodiment, when the white light produced by the white LED light sources 56 lacks light with a specific range of wavelengths, color LED light sources may also be used to create better spectral distribution according to the spirit in the first embodiment.

The back light unit introduced here may be applied to a display as the back light source of a flat display panel. In preferable embodiments, the flat display panel is a LCD panel. In contrast to the prior art, single-chip color LED light sources are used to compensate the white LED light sources producing lights with smaller spectral distribution in the present invention. Three advantages of this design are identified. First, without complicated processes and changes of materials, the improvement of color performance may be reached by optimizing the position of the color LED light sources or the mechanic design in the original back light unit in the display. Second, the single-chip LED packages with well-developed technology are used to provide the missing light with a specific range of wavelength from the white LED light sources. Since this technology is simple and economic, it may directly apply to products in mass manufacturing. It may also avoid the uncertainty in developing new materials and new technology. Third, since the brightness and intensity of the color LED sources is comparatively small, it may not affect the colorfulness of the white light from the original back light unit, but may increase the color saturation of the unit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A back light unit comprising:
a light guide plate comprising an incidence face of the light guide plate;
a light guide bar comprising a first light-incidence face and a side face connecting to the incidence face of the light guide plate, the first light-incidence face being positioned at a side of the light guide bar opposite to the incidence face of the light guide plate;
at least a white light emitting diode (LED) light source positioned at the first light-incidence face; and
at least a color LED light source positioned at a side surface of the light guide bar.

2. The back light unit of claim 1, wherein the white LED light source is a single-chip LED package.

3. The back light unit of claim 1, wherein the color LED light source is a single-chip LED package.

4. The back light unit of claim 1, wherein light produced from the white LED light source lacks a kind of light with a specific range of wavelength in comparison with natural light, and the color LED light source is a monochromatic LED light source that produces the kind of light with the specific range of wavelength.

5. The back light unit of claim 4, wherein the kind of light with the specific range of wavelength is selected from the group consisting of red light, blue light, and green light.

6. The back light unit of claim 4, wherein the white LED light source comprises only a blue LED chip and yttrium aluminum garnet (YAG) powders or other yellow-green phosphor for stimulating the light emitted by the blue LED chip to produce white light, and the color LED light source is a red LED light source or a green LED light source.

7. The back light unit of claim 1, wherein the light guide bar comprises a second light-incidence face and a third light-incidence face adjacent to the first light-incidence face.

8. The back light unit of claim 7, wherein an included angle of the second light-incidence face and the first light-incidence face is an obtuse angle, an included angle of the third light-incidence face and the first light-incidence face is an obtuse angle, and the color LED light source is positioned at the second light-incidence face or at the third light-incidence face.

9. The back light unit of claim 8, wherein a transection of the light guide bar has a trapezoid shape, the first light-incidence face being parallel with the incidence face of the light guide plate, the included angle of the second light-incidence face and the first light-incidence face being equal to the included angle of the third light-incidence face and the first light-incidence face.

10. The back light unit of claim 7, wherein the back light unit comprises a plurality of the white LED light sources and two of the color LED light sources, the white LED light sources being positioned at the first light-incidence face side by side, and the two color LED light sources being positioned at the second and the third light-incidence faces respectively.

11. The back light unit of claim 7, wherein the surface of the first light-incidence face comprises multiple prism structures which reflect light from the second or the third light-incidence face back to the light guide bar.

12. The back light unit of claim 11, wherein the prism structures are capable of adjusting angle of reflection of the light so that the light is transmitted to the light guide plate in the direction about perpendicular to the incidence face of the light guide plate.

13. The back light unit of claim 11, wherein the prism structures contains multiple V-cuts.

14. The back light unit of claim 1, wherein the first light-incidence face has a roughened surface.

15. The back light unit of claim 1, wherein the back light unit comprises a plurality of the white LED light sources, and the color LED light source is set between two of the adjacent white LED light sources side by side on the surface of the first light-incidence face.

16. The back light unit of claim 1, wherein the material of the light guide bar is the same as that of the light guide plate.

17. The back light unit of claim 1, wherein the light guide bar and the light guide plate are a monolithic structure.

18. The back light unit of claim 1, wherein the back light unit is applied to a liquid crystal display.

19. A back light unit comprising:
a light guide plate comprising an incidence face of the light guide plate;
a light guide bar comprising:
a light-exit face connecting to the incidence face of the light guide plate;
at least one light-incidence face adjacent to the light-exit face; and
a reflection face at a side surface opposite to the light-exit face, the surface of the reflection face comprising at least a prism structure for reflecting light passing into the light guide bar through the light-incidence face back to the light guide bar; and
at least a white light emitting diode (LED) light source positioned at the light-incidence face of the light guide bar.

20. The back light unit of claim 19, wherein the prism structure is capable of adjusting angles of reflection of the light so that the light is transmitted to the light guide plate in the direction about perpendicular to the incidence face of the light guide plate.

21. The back light unit of claim 19, wherein the reflection face contains a convex surface to form the prism structure.

22. The back light unit of claim 19, wherein the reflection face comprises a plurality of V-cuts.

23. The back light unit of claim 19, wherein the reflection face comprises a rough surface.

24. The back light unit of claim 19, wherein the light guide bar comprises two of the light-incidence faces on two sides of the light guide bar and next to the reflection face, and the back light unit comprises two of the white LED light sources individually set on the surface of each of the light-incidence faces of the light guide bar.

25. The back light unit of claim 19, wherein the white LED light source is a double-chip LED light package.

26. The back light unit of claim 25, wherein the double-chip LED package comprises only a blue LED, a red LED chip, and florescent powders to stimulate the light emitted by the blue LED chip and the red LED chip to produce white light.

27. The back light unit of claim 19, wherein the light produced by the white LED light source lacks a specific range of wavelength in comparison with natural light, and the back light unit comprises at least a color LED light source on the light-incidence face of the light guide bar to produce the light with the specific rage of wavelength.

28. The back light unit of claim 19, wherein the material of the light guide bar is the same as that of the light guide plate.

29. The back light unit of claim 28, wherein the light guide bar and the light guide plate are a monolithic structure.

30. The back light unit of claim 18, wherein the back light unit is applied to a liquid crystal display.

31. A method to adjust the spectral distribution of a back light unit which comprises a light guide plate and a white LED light source on one side of the light guide plate, wherein the method comprising:
comparing the spectrum diagram of white light emitted from the white LED light source and the spectrum diagram of natural light to identify a specific range of wavelength the white light lacks; and
providing a color LED light source to provide light with the specific range of wavelength so that the light from the color LED light source and the white light from the white LED light source mix in the light guide plate to create white light with a preferable color saturation.

32. The method of claim 31, wherein the white LED light source is a single-chip LED package.

33. The method of claim 31, wherein the color LED light source is a single-chip LED package.

34. The method of claim 31, wherein the light with the specific wavelength is selected from the group consisting of red, blue, and green light.

35. The method of claim 31, wherein the white LED light source comprises only a blue chip and florescent powders made of yttrium aluminum garnet (YAG) powders or other yellow-green phosphor to stimulate the light emitted by the blue LED chip to produce the white light, and the color LED light source is a red or green LED light source.

36. The method of claim 31, wherein the method comprises further providing a light guide bar connecting to the light guide plate, the light guide bar being among the light guide plate, the white LED light source, and the color LED light source.

37. The method of claim 36, wherein the method further comprises modifying incidence angles of the light produced by the color LED light source passing into the light guide bar by adjusting the surface of the light guide bar.

38. The method of claim 36, wherein the method further comprises setting a reflection face on a surface of the light guide bar for reflecting light incident on the reflection face in the light guide bar back to the light guide bar.

39. The method of claim 38, wherein the surface of the reflection face comprises a plurality of V-cuts.

40. The method of claim 39, wherein the method further comprises modifying reflection angles of the light by adjusting the angles and pitches of the V-cuts.
